(19) United States
(12) Patent Application Publication
(10) Pub. No.: US 2015/0234624 A1
(43) Pub. Date: Aug. 20, 2015

(54) USER AUTHENTICATION SYSTEM

(71) Applicant: Sharp Kabushiki Kaisha, Osaka (JP)

(72) Inventors: Yukako NII, Osaka-shi (JP); Yasutomo HAYANO, Osaka-shi (JP); Koichi MURAKAMI, Osaka-shi (JP); Kyosuke TAKA, Osaka-shi (JP)

(21) Appl. No.: 14/625,717

(22) Filed: Feb. 19, 2015

(30) Foreign Application Priority Data
Feb. 20, 2014 (JP) 2014-030743

(51) Int. Cl. G06F 3/12; H04L 29/06

(52) U.S. Cl. CPC G06F 3/1238; H04L 63/083; G06F 3/1273

(57) ABSTRACT

A portable terminal includes a first sound output unit and a first sound input unit, and an image forming apparatus includes a second sound output unit, a second sound input unit, an authentication information generating unit generating a security code, a storage unit storing the generated security code, and an authentication confirmation unit performing a user authentication by using the security code. When the first sound input unit receives a first synthesized sound, which includes the stored security code and is outputted from the second sound output unit, the first sound output unit outputs a second synthesized sound including the security code extracted from the received first synthesized sound, and the authentication confirmation unit determines that a user authentication is successful when the stored security code and the security code extracted from the received second synthesized sound match.

### BACKGROUND OF THE INVENTION

1. Field of the Invention

The present invention relates to a user authentication system, and more particularly to a user authentication system that can authenticate a user using an image forming apparatus connected to a network by utilizing a portable terminal carried by the user.

2. Description of the Background Art

Recently, a user prints a document or a photograph created with a personal computer by using an image forming apparatus connected to a network.

A multifunction peripheral having multiple functions such as a printing function, a copying function, a scanner function, and a facsimile function is placed in a convenience store or a public space in a station, and a user prints information, including a document or a photograph, stored in the user's portable terminal through a wireless communication between the multifunction peripheral and the user's portable terminal.

For example, a wireless communication unit for transmitting and receiving radio waves that can be transmitted and received to and from a portable terminal is provided to a multifunction peripheral. After a user performs a predetermined input operation, such as an input of a password, on a multifunction peripheral and a user's portable terminal for an authentication of the user and for an allowance of a connection between the multifunction peripheral and his/her portable terminal, the user transmits desired information to the multifunction peripheral from his/her portable terminal to print this information with the multifunction peripheral.

A system described below has also been proposed (see Japanese Unexamined Patent Publication No. 2006-330856). In this system, a special function for transmitting and receiving radio waves is not provided to a multifunction peripheral, but a phone number of a cellular phone is used as user identification information. This system performs a user authentication by utilizing a cellular phone, and then, prints an electronic document, for example.

In Japanese Unexamined Patent Publication No. 2006-330856, a multifunction peripheral needs an input of a phone number of a user's cellular phone, and encourages a user to input the phone number of his/her cellular phone.

The multifunction peripheral automatically calls the inputted cellular phone number, and after the user responds to this calling on his/her cellular phone, he/she listens to a sound message transmitted from the multifunction peripheral.

The user inputs a password included in this sound message as a response by using an operation panel on the multifunction peripheral. Then, the multifunction peripheral compares the password included in the sound message and the password inputted as the response. When they successfully match, the multifunction peripheral ends the authentication process. Then, the multifunction peripheral acquires a desired electronic document stored beforehand in a document server from the document server, and executes a predetermined output process.

However, a multifunction peripheral conventionally used needs an input procedure for a user authentication before executing actual printing of documents, and needs an input operation to the multifunction peripheral and an input operation for setting on a user's terminal as the input procedure. In addition, when data is transmitted to a multifunction peripheral from a user's portable terminal, a password different from the password for the authentication procedure is sometimes required to be inputted. The input of two different passwords confuses the user.

The input operation described above is a rather complicated and time-consuming. Therefore, a user has a great burden on an input operation.

In conventional system, a user inputs a phone number of his/her cellular phone and a password on a multifunction peripheral for a user authentication. Therefore, a user has a great burden on his/her input operation.

If a cellular phone number is stolen by a third person, and this third person abuses the stolen phone number on the other cellular phone, a user authentication can be sometimes performed by using any cellular phone. Therefore, this conventional system has not enough security.

### SUMMARY OF THE INVENTION

The present invention is accomplished in view of the above circumstances, and aims to provide a user authentication system that can reduce a burden of a user, who uses an image forming apparatus, for an input operation with a transmission and reception of sound information including a security code between a user's portable terminal and the image forming apparatus.

The present invention provides a user authentication system including: a portable terminal and an image forming apparatus, the portable terminal including a first sound output unit outputting a synthesized sound; and a first sound input unit receiving a synthesized sound outputted from the image forming apparatus, and the image forming apparatus including a second sound output unit outputting a synthesized sound; a second sound input unit receiving the synthesized sound outputted from the portable terminal; an authentication information generating unit generating a security code used for a user authentication; a storage unit storing the generated security code; and an authentication confirmation unit performing a user authentication by using the security code, wherein, the second sound output unit in the image forming apparatus outputs a first synthesized sound including the security code, when the first sound input unit in the portable terminal receives the first synthesized sound, the first sound output unit outputs a second synthesized sound including the security code extracted from the received first synthesized sound, the authentication confirmation unit compares the stored security code and the security code extracted from the second synthesized sound received by the second sound input unit, and when both security codes match, the authentication confirmation unit determines that a user authentication is successful.

According to this configuration, when the first sound input unit in the portable terminal receives the first synthesized sound outputted from the image forming apparatus, the first sound output unit outputs a second synthesized sound including the security code extracted from the first synthesized sound, and the authentication confirmation unit determines that the authentication is successful when the stored security code and the security code extracted from the received second synthesized sound match each other. Therefore, an operation of inputting a setting for a user authentication can be eliminated, whereby a burden of a user for an input operation can be reduced.

### BRIEF DESCRIPTION OF THE DRAWINGS

FIG. 1 is an explanatory view illustrating a schematic configuration of a user authentication system according to the present invention;

FIG. 2 is a block diagram illustrating a configuration of a user terminal TE according to one embodiment;

FIG. 3 is a block diagram illustrating a configuration of an image forming apparatus PC according to one embodiment;

FIG. 4 is a block diagram illustrating a configuration of a management server SV according to one embodiment;

FIG. 5 is an explanatory view of a sequence of a user authentication and a data printing according to a first embodiment of the present invention; and

FIG. 6 is an explanatory view of a sequence of a user authentication and a data printing according to a second embodiment of the present invention.

### DESCRIPTION OF THE PREFERRED EMBODIMENTS

The present invention also provides a user authentication system including: a portable terminal carried by a user and an image forming apparatus having functions, one of which is desired and used by a user, the portable terminal including a first sound output unit outputting a synthesized sound; a first sound input unit receiving a synthesized sound outputted from the image forming apparatus; a first communication unit; a first sound synthesizing unit generating a synthesized sound to be outputted from the first sound output unit; and a first input sound analyzing unit analyzing the synthesized sound received by the first sound input unit, and the image forming apparatus including a second sound output unit outputting a synthesized sound; a second sound input unit receiving the synthesized sound outputted from the portable terminal; a second communication unit; a second sound synthesizing unit generating the synthesized sound to be outputted from the second sound output unit; a second input sound analyzing unit analyzing the synthesized sound received by the second sound input unit; an authentication information generating unit generating a security code used for a user authentication; a storage unit storing the generated security code; and an authentication confirmation unit confirming whether data communication between the portable terminal and the image forming apparatus is allowed or not by using the stored security code, wherein the image forming apparatus generates a first synthesized sound, which includes the security code generated by the authentication information generating unit, by the second sound synthesizing unit, and outputs the generated first synthesized sound from the second sound output unit, the portable terminal receives the outputted first synthesized sound by the first sound input unit, then, extracts the security code included in the received first synthesized sound by the first input sound analyzing unit, generates a second synthesized sound including the extracted security code by the first sound synthesizing unit, and outputs the generated second synthesized sound from the first sound output unit, the image forming apparatus receives the outputted second synthesized sound by the second sound input unit, and then, extracts the security code included in the received second synthesized sound by the second input sound analyzing unit, and when the stored security code and the security code extracted from the received second synthesized sound match, the authentication confirmation unit determines that an authentication is successful, and allows the data communication between the portable terminal and the image forming apparatus via the first communication unit and the second communication unit.

According to another aspect of the present invention, the image forming apparatus further includes a motion sensor sensing that a human body is present within a predetermined distance, and the second sound output unit outputs the first synthesized sound including the security code stored in the storage unit, when the motion sensor senses a human body.

With this configuration, when the motion sensor senses that a human body is present within a predetermined distance from the image forming apparatus, the image forming apparatus outputs a first synthesized sound including the security code. Therefore, a user carrying the portable terminal can easily allow the image forming apparatus to start a user authentication process without performing an input operation for starting the user authentication process.

According to another aspect of the present invention, the first and second synthesized sounds include the security code and a predetermined sound message, and the security code is synthesized as a sound having a frequency band in a non-audible area.

With this configuration, the security code included in the outputted synthesized sound is synthesized as a sound with a frequency band in a non-audible area. Therefore, this security code is inaudible to human ears, whereby the user authentication system can carry out the user authentication process without allowing a user to recognize the user authentication process.

According to another aspect of the present invention, the first and second synthesized sounds include the security code and a predetermined sound message, and the security code and the sound message are respectively synthesized as sounds, each having a different frequency band to be outputted, simultaneously mixed, and outputted from the first and second sound output units.

According to another aspect of the present invention, the security code includes a network ID and a password for identifying a portable terminal.

According to another aspect of the present invention, after the user authentication by the authentication confirmation unit becomes successful, information that should be processed by the image forming apparatus is transmitted to the image forming apparatus from the portable terminal.

The present invention also provides an image forming apparatus having a function for performing a user authentication, the image forming apparatus including: a sound output unit outputting a synthesized sound; a sound input unit receiving a synthesized sound outputted from a portable terminal; a communication unit; a sound synthesizing unit generating the synthesized sound to be outputted from the sound output unit; an input sound analyzing unit analyzing the synthesized sound received by the sound input unit; an authentication information generating unit generating a security code used for a user authentication; a storage unit storing the generated security code; and an authentication confirmation unit confirming whether data communication between the portable terminal and the image forming apparatus is allowed or not by using the stored security code, wherein the sound synthesizing unit generates a first synthesized sound including the security code generated by the authentication information generating unit, the sound output unit outputs the first synthesized sound, and after the sound input unit receives a second synthesized sound outputted from the portable terminal, the input sound analyzing unit extracts a security code included in the received second synthesized sound, and when the stored security code and the security code extracted from the received second synthesized sound match, the authentication confirmation unit determines that an authentication is successful and allows the data communication between the portable terminal and the image forming apparatus.

The present invention also provides a user authentication process for a system including a portable terminal and an image forming apparatus, the portable terminal including a first sound output unit outputting a synthesized sound; and a first sound input unit receiving a synthesized sound outputted from the image forming apparatus, and the image forming apparatus including a second sound output unit outputting a synthesized sound; a second sound input unit receiving the synthesized sound outputted from the portable terminal; an authentication information generating unit generating a security code used for a user authentication; a storage unit storing the generated security code; and an authentication confirmation unit performing a user authentication by using the security code, the process including:

outputting a first synthesized sound including the stored security code from the second sound output unit in the image forming apparatus, receiving the first synthesized sound by the first sound input unit in the portable terminal; outputting a second synthesized sound, which includes the security code extracted from the received first synthesized sound, from the first sound output unit; comparing the stored security code and the security code extracted from the second synthesized sound received by the second sound input unit by the authentication confirmation unit; and determining by the authentication confirmation unit that a user authentication is successful when both security codes match.

Embodiments of the present invention will be described with reference to the drawings. The present invention is not limited by the description of the embodiments below.

### Schematic Configuration of User Authentication System

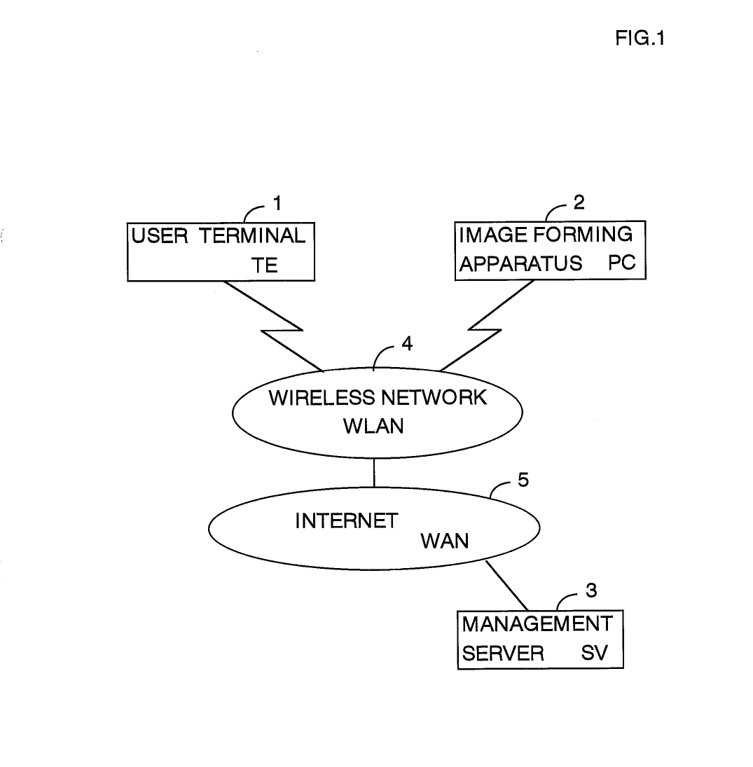

FIG. 1 is an explanatory view illustrating a schematic configuration of a user authentication system according to the present invention.

In FIG. 1, the user authentication system according to the present invention mainly includes a user terminal TE1, an image forming apparatus PC2, and a management server SV3.

The user terminal TE1 (hereinafter merely referred to as TE) is an information processing device carried by a user, and it is a portable terminal such as a notebook computer, a cellular phone, a smartphone, or a tablet terminal.

The image forming apparatus PC2 (hereinafter merely referred to as PC) is an information processing apparatus that outputs information such as a desired document or an image, and it corresponds to a printer, a copying machine, or a multifunction peripheral, for example. A multifunction peripheral is an information processing apparatus having a lot of functions including a printer function, a copying function, a scanner function, a facsimile function, and a network connection function.

The user terminal TE1 and the image forming apparatus PC2 both have a network connection function. Especially, it is supposed that the user terminal TE1 and the image forming apparatus PC2 have a function of performing communication with each other via a wireless network (wireless LAN: WLAN) 4.

In the present invention, the user terminal TE1 and the image forming apparatus PC2 are configured to have a function of inputting and outputting a sound. As described later, they include a sound synthesizing unit, a sound output unit, and a sound input unit.

The management server SV3 (hereinafter merely referred to as SV) stores information, such as a document or an image, generated by a user with the user terminal TE1 for each user. The management server SV3 is connected to the user terminal TE1 and the image forming apparatus PC2 via WAN5 such as the Internet. Information generated by the user terminal TE1 is transmitted to the management server SV3 via the WLAN 4 and the WAN 5, according to need, and stored so as to be accessible from an information processing apparatus other than the user terminal TE1, e.g., from the image forming apparatus PC2.

When the information generated by the user is stored in the user terminal TE1, the management server SV3 is not necessarily provided. In other words, the user authentication system according to the present invention may be configured by the user terminal TE 1 and the image forming apparatus PC2.

In the present invention, when communication is performed between two apparatuses, a user authentication process is performed to achieve sufficient security as in data communication using a conventional network. Especially when a user utilizes the image forming apparatus PC2, the present invention has a feature of performing a user authentication process through transmission and reception of a synthesized sound including predetermined authentication information between his/her user terminal TE1 and the image forming apparatus PC2.

### Configuration of User Terminal TE

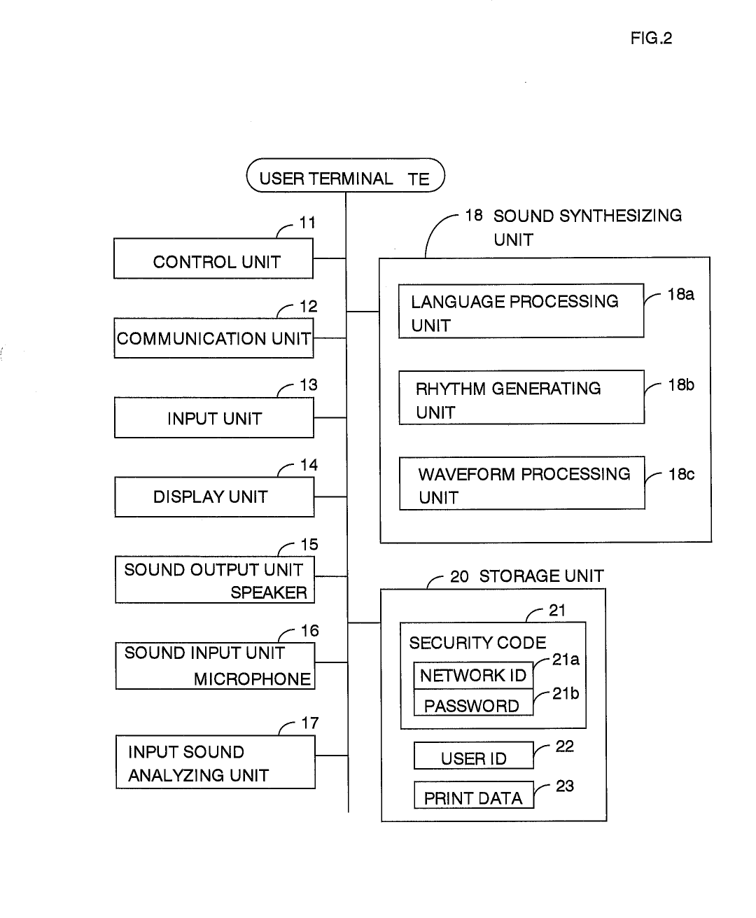

FIG. 2 is a block diagram illustrating a configuration of the user terminal TE1 according to one embodiment.

The user terminal TE1 includes a control unit 11, a communication unit 12, an input unit 13, a display unit 14, a sound output unit 15, a sound input unit 16, an input sound analyzing unit 17, a sound synthesizing unit 18, and a storage unit 20.

The control unit 11 is implemented by a microcomputer mainly including a CPU, a ROM, a RAM, an I/O controller, and a timer. The control unit 11 is a section that executes various functions, such as a communication function and a sound synthesizing function, of the user terminal TE through organic operations of various types of hardware by the CPU based on a program stored in the ROM, for example.

The communication unit 12 corresponds to the first communication unit, and it is a section connected to a network such as a wireless network WLAN4 to perform data communication with the other information processing apparatuses including the image forming apparatus PC2 and the management server SV3.

Any communication systems conventionally used can be used for a communication system. Either one of wired communication and wireless communication may be used. However, if a terminal having portability is used as the user terminal, a wireless communication function is preferably used.

The input unit 13 is a section that executes an input of information such as characters or graphics, an input of various set information, and an input of selecting a function. For example, a keyboard, a mouse, or a touch panel can be used as the input unit 13.

The display unit 14 is a section that displays information necessary for executing each function in the present invention. An LCD, or an organic EL display is used as the display unit 14, for example.

The sound output unit 15 is a section that outputs a synthesized sound, and it is sometimes referred to as a speaker below.

The sound input unit 16 is a section to which a sound is inputted, and it is sometimes referred to as a microphone. The sound input unit 16 is especially a section that receives a synthesized sound outputted from the image forming apparatus. The sound output unit 15 corresponds to the first sound output unit, and the sound input unit 16 corresponds to the first sound input unit.

As described later, in the present invention, when a user carrying the user terminal TE approaches the image forming apparatus PC, a sound is transmitted and received between the TE and the PC, whereby an authentication process is executed. Accordingly, a volume of a sound outputted from the speaker is set such that a sound outputted from the speaker of the TE can be received by a microphone of the counterpart PC when the distance between the TE and the PC is about 1 to 2 m.

The input sound analyzing unit 17 corresponds to the first input sound analyzing unit, and it is a section that analyzes a detail of a synthesized sound received by the microphone 16.

Specifically, in the case where the received synthesized sound includes a security code, the input sound analyzing unit 17 analyzes a frequency component of the synthesized sound to extract a security code included in the received sound.

The sound synthesizing unit 18 corresponds to the first sound synthesizing unit, and it is a section that generates a synthesized sound that is to be outputted from the speaker 15.

The sound synthesizing unit 18 is mainly composed of a language processing unit 18a, a rhythm generating unit 18b, and a waveform processing unit 18c.

A synthesized sound includes a sentence (sound message) expressed by a language a human can understand and a security code. The sentence and the security code are mixed and simultaneously outputted.

A sentence is outputted with a sound waveform using an audible frequency band (e.g., 300 Hz to 4000 Hz) audible to human ears.

For example, the sound synthesizing unit 18 outputs a greeting phrase (Hello) that is outputted when a user comes to the image forming apparatus PC he/she intends to use, or a phrase (Push a start button) for showing how to operate upon selecting a function, with a Japanese language or another language.

On the other hand, the security code is outputted with a sound waveform having a non-audible frequency band (e.g., 20 kHz to 100 kHz) for preventing the sentence simultaneously outputted from being inaudible.

Specifically, a frequency band of the security code is set different from the frequency band of the sentence in order that the security code can be separated from the inputted synthesized sound.

The security code includes a network ID and a password as described later. For example, the security code is expressed by plural numerals, plural alphabets, or a combination of plural numerals and alphabets, such as 1234, abc, or 234as.

In the case where the security code is outputted as a signal with a non-audible frequency band that is inaudible to human ears, the security code may be a combination of characters or symbols other than numerals or alphabets, or may be a combination of meaningless modulation signals.

The language processing unit 18a is a section that performs a language analysis to the sentence and the security code to be outputted, and applies reading or accent generally used to the sentence by using a dictionary.

The rhythm generating unit 18b is a section that determines a rhythm and intonation when the sentence is outputted as a sound.

The waveform processing unit 18c is a section that generates sound waveforms of the sentence and the security code to be outputted. For example, the waveform processing unit 18c stores beforehand sound-waveform data for each numeral or each character. The waveform processing unit 18c selects sound-waveform data for characters forming a sentence or a security code to be outputted, and connects selected plural sound-waveform data pieces in order that the sentence becomes smooth as Japanese phrase, considering the reading or accent determined by the language processing unit 18a and the rhythm determined by the rhythm generating unit 18b.

A synthesized sound of a sentence and a synthesized sound of a security code, each having a different frequency, are mixed and outputted in order that they are outputted at almost the same timing.

Two synthesized sounds may be mixed such that the sentence and the security code can be separated by the analysis of the received input sound, and the mixing manner is not particularly limited. For example, two synthesized sounds may be mixed in such a manner that numerals of the security code are sandwiched between characters forming the sentence.

The timing of outputting a synthesized sound of a sentence and the timing of outputting a synthesized sound of a security code may be shifted to each other. For example, a synthesized sound of a security code that is inaudible to human ears may be outputted just after a synthesized sound of a sentence is outputted.

The storage unit 20 is a section that stores information used upon the execution of functions of the user terminal TE, set information, or a program. For example, a semiconductor memory device such as a ROM, a RAM, or a flash memory, a storage device such as HDD or SSD, or other storage mediums may be used for the storage unit 20.

The storage unit 20 mainly stores a security code 21, a user ID 22, and print data 23. Although not illustrated, the storage unit 20 also stores beforehand a dictionary used for the language process, the rhythm generation, and the waveform process, information of rhythm, or sound-waveform data, for example.

The security code 21 is information generated by the image forming apparatus PC2 a user intends to use, and transmitted from the PC2. The security code 21 is composed of a network ID 21a and a password 21b, for example.

The network ID 21a is information for specifying a wireless LAN connecting the TE1 and the PC2, and the password 21b is information for identifying the TE1.

After receiving a synthesized sound transmitted from the PC2 with the microphone 16, the TE1 extracts the security code 21 included in the received synthesized sound by the input sound analyzing unit 17, and stores the extracted security code 21 into the storage unit 20. As described later, the security code 21 stored in the storage unit 20 in the TE1 or the password 21b that is a part of the security code 21 is transmitted to the PC2, whereby the PC2 performs a predetermined authentication process.

The security code 21 is not limited to the one described above. When the TE1 and the PC2 directly communicate with each other without using the wireless LAN, a security code 21, which does not include a network ID but includes only information corresponding to a password, may be used.

The user ID 22 is information for identifying a user, and it corresponds to a passcode a user sets beforehand to use the TE1.

As described later, the user ID 22 is transmitted to the management server SV3 in association with the print data 23, and this user ID 22 is used upon actually printing the print data with the PC2.

The print data 23 is information of a document, graphic, or photograph generated by the user with the TE1, or information of an image acquired from other devices or storage mediums. The print data 23 is information that should be processed by the PC2. In the embodiments described below, the print data 23 primarily means data that is intended to be printed by the PC2.

### Configuration of Image Forming Apparatus

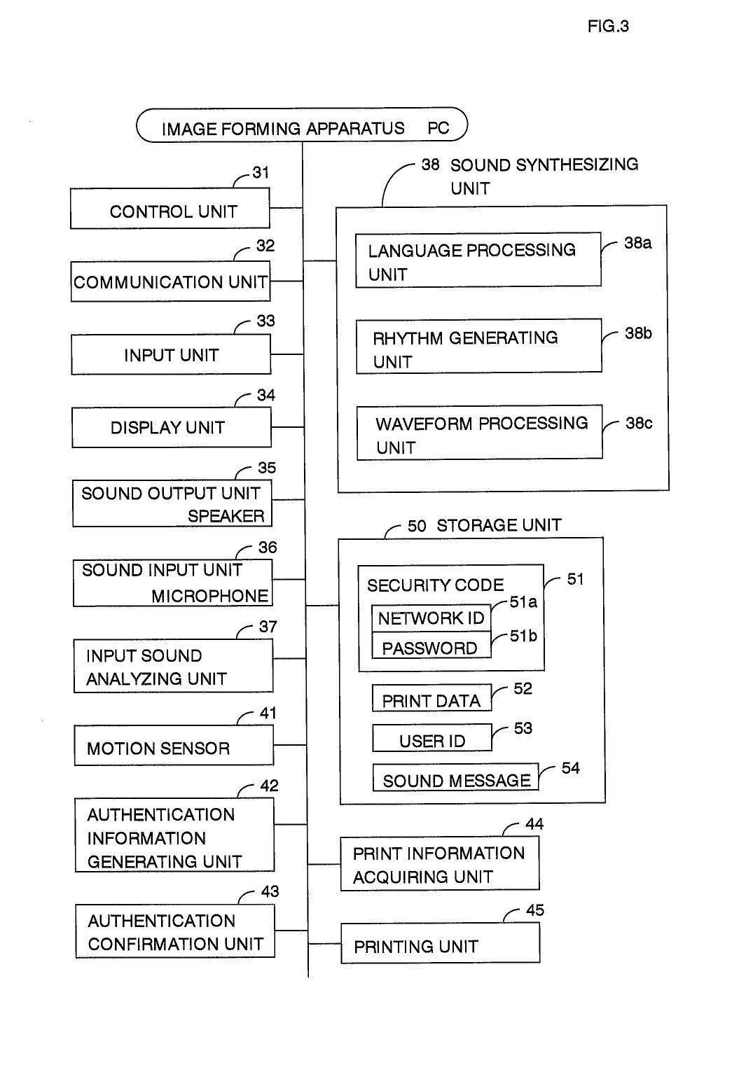

FIG. 3 is a block diagram illustrating a configuration of an image forming apparatus according to one embodiment of the present invention.

The embodiments below describe that the image forming apparatus PC2 mainly prints print data generated by a user. However, instead of the image forming apparatus PC2, a multifunction peripheral MFP having a copying function, a scanner function, and a facsimile function in addition to a printing function may be used.

In FIG. 3, the image forming apparatus PC2 mainly includes a control unit 31, a communication unit 32, an input unit 33, a display unit 34, a sound output unit 35, a sound input unit 36, an input sound analyzing unit 37, a sound synthesizing unit 38, a motion sensor 41, an authentication information generating unit 42, an authentication confirmation unit 43, a print information acquiring unit 44, a printing unit 45, and a storage unit 50.

The control unit 31 is a section composed of a microcomputer including a CPU and executing various functions of the PC2. The control unit 31 executes various functions, such as an authentication function and a printing function, of the PC2 through organic operations of various types of hardware by the CPU based on a program stored in the ROM, for example.

The communication unit 32, the input unit 33, the display unit 34, the sound output unit (speaker) 35, the sound input unit (microphone) 36, the input sound analyzing unit 37, and the sound synthesizing unit 38 having the configurations and functions similar to those in the user terminal TE1 may be used.

The sound synthesizing unit 38 is also composed of a language processing unit 38a, a rhythm generating unit 38b, and a waveform processing unit 38c, as in the user terminal TE1.

The motion sensor 41 senses the presence of a human within a predetermined distance (e.g., within 1 to 2 m) from the PC2. For example, a temperature sensor, an infrared sensor, a ultrasonic sensor, or a visible sensor can be used for the motion sensor 41.

When the motion sensor 41 senses a body of a human who approaches the PC2, an authentication process is started between the TE1 carried by the user who intends to use the PC2 and the PC2. Specifically, the speaker 35 in the PC2 outputs a synthesized sound including a predetermined sound message and a security code. This synthesized sound corresponds to the first synthesized sound.

In order to prevent the image forming apparatus PC2 from starting the authentication process only when a human merely passes near the PC2, the image forming apparatus PC2 may be configured to check whether or not a sensing state is continued for a certain period of time or more, and to start the authentication process when the sensing state of a human body is continued for two or more seconds.

Alternatively, in order to allow the image forming apparatus PC2 to surely start the authentication process, a predetermined push-button switch is mounted in addition to the motion sensor of a non-contact type, and when a human pushes this switch, the PC2 may start the authentication process using a synthesized sound.

The authentication information generating unit 42 is a section generating authentication information for a user authentication.

Specifically, the authentication information generating unit 42 is a section generating a security code 51 utilized for a user authentication in order to allow the connection with the TE1 and the data communication with the TE1.

The security code 51 is composed of a network ID 51a and a password 51b as described above, for example.

The network ID 51a is determined by a WLAN4 to be used. On the other hand, any data is generated for the password 51a by using random numbers to avoid an issuance of the same password.

The generated security code 51 is converted into sound data, and outputted from the speaker 35 as a synthesized sound together with the sound message 54.

The authentication confirmation unit 43 is a section performing an authentication of a user who intends to use the PC2 by utilizing the security code 51, i.e., it is a section confirming whether or not a connection and data communication are allowed or not between the PC2 and the TE1 carried by the user. In the present invention, sound information is used for the user authentication.

In this user authentication, the security code stored in the storage unit 50 and the security code extracted from the synthesized sound received by the sound input unit 36 are compared. When both security codes match, the user authentication is determined to be successful. When the user authentication is successful, the data communication between the TE1 and the PC2 is allowed via the communication units of the TE1 and the PC2.

As described later, in the case where the synthesized sound returned to the PC2 from the TE1 includes data same as the password 51b in the security code 51 generated by the PC2 and transmitted to the TE1, the authentication confirmation unit 43 determines that the authentication is successful, and allows the data communication. The authentication confirmation unit 43 may check not only the password 51b but also the whole security code including the network ID 51a.

In the case where the TE1 stores print information, the information (print information) that should be processed by the PC2 is transmitted to the PC2 via the communication unit 12 in the TE1, after the user authentication is successful.

The print information acquiring unit 44 is a section acquiring information (hereinafter referred to as print data) that should be printed on a sheet.

The print data is document data or image data such as a graphic or photograph, for example, and this print data is acquired from the management server SV3 or the user terminal TE1 as described later.

The printing unit 45 is a section printing the acquired print data onto a sheet.

The storage unit 50 is a section that stores information used upon the execution of functions of the image forming apparatus PC2 and a program.

For example, a semiconductor memory device such as a ROM, a RAM, or a flash memory, a storage device such as HDD or SSD, or other storage mediums may be used for the storage unit 50.

The storage unit 50 stores the security code 51, print data 52, a user ID 53, and a sound message 54, for example.

The security code SC51 is information generated by the PC2 for authenticating a user carrying the TE1.

The security code SC51 includes a network ID 51a for distinguishing a network, and a password 51b for identifying a user and the TE1.

The network ID 51a and the password 51b are information (e.g., 234as, cd-001n) with plural digits formed by combining plural numbers, alphabets, and symbols.

The print data 52 is data to be printed by the printing unit 45. The print data 52 may be temporarily stored, and deleted after being printed.

The user ID 53 is information inputted by a user with the input unit 33, and this is information used when the PC2 acquires print data of this user.

The sound message 54 is a synthesized sound that should be outputted from the speaker 35, and it is stored beforehand.

The synthesized sound that should be outputted may be a sentence that can be understood by a human, music, a mere audible sound, or a sound in an area inaudible to human ears.

The sound message and the security code SC51 are synthesized, and outputted from the speaker 35.

### Configuration of Management Server

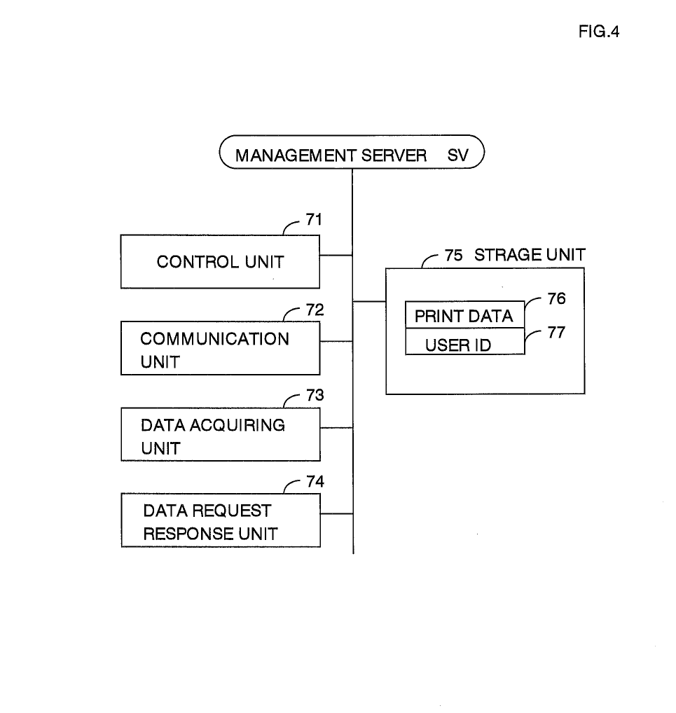

FIG. 4 is a block diagram illustrating a configuration of the management server according to one embodiment of the present invention.

In the present invention, the management server SV3 is configured to have a function of storing print data of a user transmitted from the TE1, and transmitting print data to a user required from the PC2 to the PC2. However, the management server SV3 may have other functions.

In FIG. 4, the management server SV3 mainly includes a control unit 71, a communication unit 72, a data acquiring unit 73, a data request response unit 74, and a storage unit 75.

The control unit 71 and the communication unit 72 may have configurations and functions same as those in the TE and the PC.

An apparatus of a carrier or an apparatus of a database provider can be used for the management server SV3. Therefore, the communication unit 72 can preferably be connected to the WAN5 such as the Internet.

The data acquiring unit 73 is a section that acquires information transmitted from the TE1 of a user via the communication unit 72, and stores the transmitted information into the storage unit 75.

For example, the data acquiring unit 73 acquires a user ID specifying a user and print data generated by the user.

The storage unit 75 stores data or a program for executing each function of the SV3, and further stores information transmitted from a user terminal TE for each user.

For example, the storage unit 75 stores print data 76 acquired by the data acquiring unit 73 and a user ID 77 in association with each other.

The data request response unit 74 is a section that transmits information corresponding to a request from the image forming apparatus PC2 to the PC2.

For example, when receiving request data including a user ID transmitted from the PC2, the data request response unit 74 searches the storage unit 75 to read print data 76 corresponding to this user ID, and transmits the read print data to the PC2 from which the request data is transmitted.

### First Embodiment of User Authentication and Data Printing

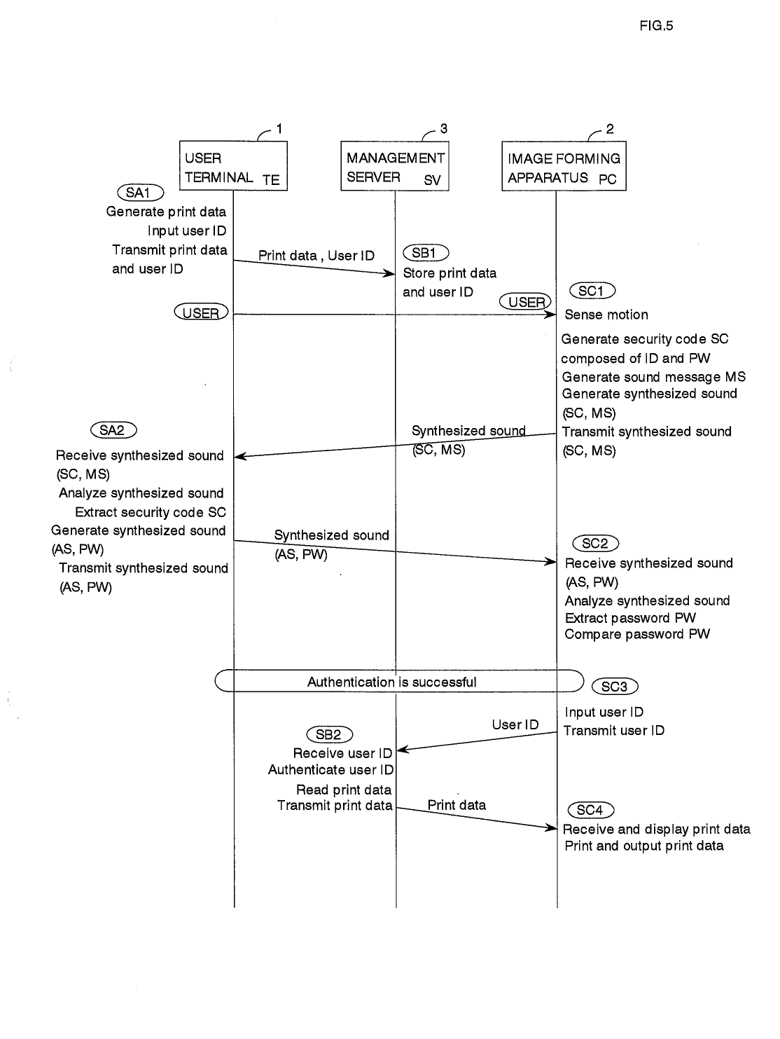

FIG. 5 is an explanatory view illustrating a sequence of a user authentication and data printing according to a first embodiment of the present invention.

This embodiment describes that data, which is generated by a user and which should be printed, is temporarily stored in the SV3, and the user carrying the TE1 comes to the PC2 to print his/her data to be printed on the PC2.

It is supposed that the image forming apparatus PC2 is installed at a store such as a supermarket or a convenience store. The conceivable case is such that a user temporarily stores data generated at home or at his/her office in the SV3, and after leaving home, he/she stops at the store to print the data stored by the user.

In step SA1 in FIG. 5, a user generates print data 23 with his/her user terminal TE1, applies his/her user ID 22, and stores this data into the storage unit 20.

The user also transmits the generated print data 23 and the user ID 22 to the management server SV3.

In step SB1, the SV3 stores the print data 76 and the user ID 77, which are transmitted from the TE1, into the storage unit 75 in association with each other.

Thereafter, the user carrying the TE1 visits a store where the image forming apparatus PC2 is installed, and he/she comes close to the PC2.

In step SC1, when the user falls within a sensing area of the motion sensor 41 of the PC2, the motion sensor 41 senses this user.

When the PC2 senses a human body, the authentication information generating unit 42 generates a security code SC51 including a network ID and a password PW.

The sound synthesizing unit 38 selects a sound message MS54, which should be outputted from the speaker 35, from the storage unit 50, and generates a synthesized sound.

At the same time, the sound synthesizing unit 38 generates a synthesized sound corresponding to the generated security code SC51, and also generates a synthesized sound formed by mixing the sound message MS and the security code SC.

The sound message MS and the security code SC may be mixed in any one of the above-mentioned methods set beforehand.

For example, the security code SC is included in the synthesized sound as a sound signal with a frequency band inaudible to human ears.

Then, the synthesized sound (SC, MS) including the sound message MS and the security code SC is outputted from the speaker 35 of the PC2.

For example, a sentence understandable by the user, such as “Hello”, may be outputted with the Japanese language etc. as the sound message MS.

When hearing this sound message, the user close to the PC2 can recognize that the PC can be used.

In step SA2, the microphone 16 of the TE1 carried by the user receives the outputted synthesized sound (SC, MS).

The input sound analyzing unit 17 of the TE1 analyzes the received synthesized sound, and extracts the security code SC included in this synthesized sound.

In the present embodiment, the input sound analyzing unit 17 recognizes the network ID and the password PW forming the security code SC, and stores the network ID and the password PW into the storage unit 20.

Then, the sound synthesizing unit 18 generates a synthesized sound (AS, PW) indicating a reply.

This synthesized sound includes a reply message AS and the password PW included in the extracted security code SC.

The reply message may be a sound in an audible area. However, the password PW is preferably synthesized as a sound having an inaudible frequency.

The synthesized sound (AS, PW) including the reply message AS and the password PW is outputted from the speaker 15 of the TE.

In step SC2, the outputted synthesized sound (AS, PW) is received by the microphone 36 of the PC2.

The input sound analyzing unit 37 analyzes the received synthesized sound (AS, PW) to extract the password PW included in the synthesized sound.

Thereafter, the authentication confirmation unit 43 of the PC2 compares the extracted password PW and a password PW51b in the security code 51 generated by the PC2 and stored in the storage unit 50. When both passwords PW match, the authentication confirmation unit 43 determines that the user authentication is successful.

When the user authentication becomes successful, the data communication between the TE1 and the PC2 is allowed, whereby the user can perform a predetermined input operation for data printing on the PC2, and can acquire print data from the SV3.

When the user authentication is successful, the display unit 34 displays that the authentication is successful, or the speaker 35 outputs a sound indicating that the authentication is successful. In addition, the PC2 may display to the user or inform the user that he/she can perform his/her desired input operation for data printing, for example, because of the successful authentication.

In step SC3, the user depresses a key requesting printing and inputs a user ID from the input unit 33 of the PC2 to print the print data, which is generated by the user and stored in the server SV3, on the PC2.

This user ID is the same as the user ID inputted in step SA1.

The inputted user ID is transmitted to the SV3.

In step SB2, the request response unit 74 of the SV3 receives the user ID, and authenticates the user ID.

In the present embodiment, the data response request unit 74 compares the received user ID and the user ID 77 stored in the storage unit 75 of the SV3 to check whether the user ID77 matching the received user ID is present or not in the storage unit 75.

When the matching user ID 77 is present, the data request response unit 74 reads print data 76 corresponding to this user ID 77, and transmits the print data 76 to the PC2 that transmits the user ID.

In step SC4, the print information acquiring unit 44 of the PC2 acquires the print data 52, and temporarily stores the acquired print data in the storage unit 50.

The print information acquiring unit 44 displays information relating to the acquired print data, e.g., information such as a name, a name of a creator or a created date of the print data, or a part or all of the detail of the print data, on the display unit 34.

Thereafter, the user confirms the displayed information, and performs an input operation for allowing printing. Then, the printing unit 45 prints the print data 52 temporarily stored onto a predetermined sheet.

As described above, when a user intends to print print data generated by the user on the PC2 at a store outside home, a user authentication process using a synthesized sound is performed between the TE1 and the PC2 only when the user comes close to the PC2 with the TE1.

Specifically, the user authentication is automatically performed, even if the user coming close to the PC2 does not read a description displayed on the display unit 34 of the PC2, and even if the user does not perform a predetermined input operation with the input unit 33. This can reduce a burden of for an input operation of a user who intends to use the PC2.

For example, a conventional PC2 needs a fingerprint authentication that requires a user to touch his/her finger on a predetermined position, or a keyword authentication that requires a user to input a password with a keyboard, upon a user authentication. However, the present invention has no need to perform an input operation that is conventionally required for an authentication.

### Second Embodiment of User Authentication and Data Printing

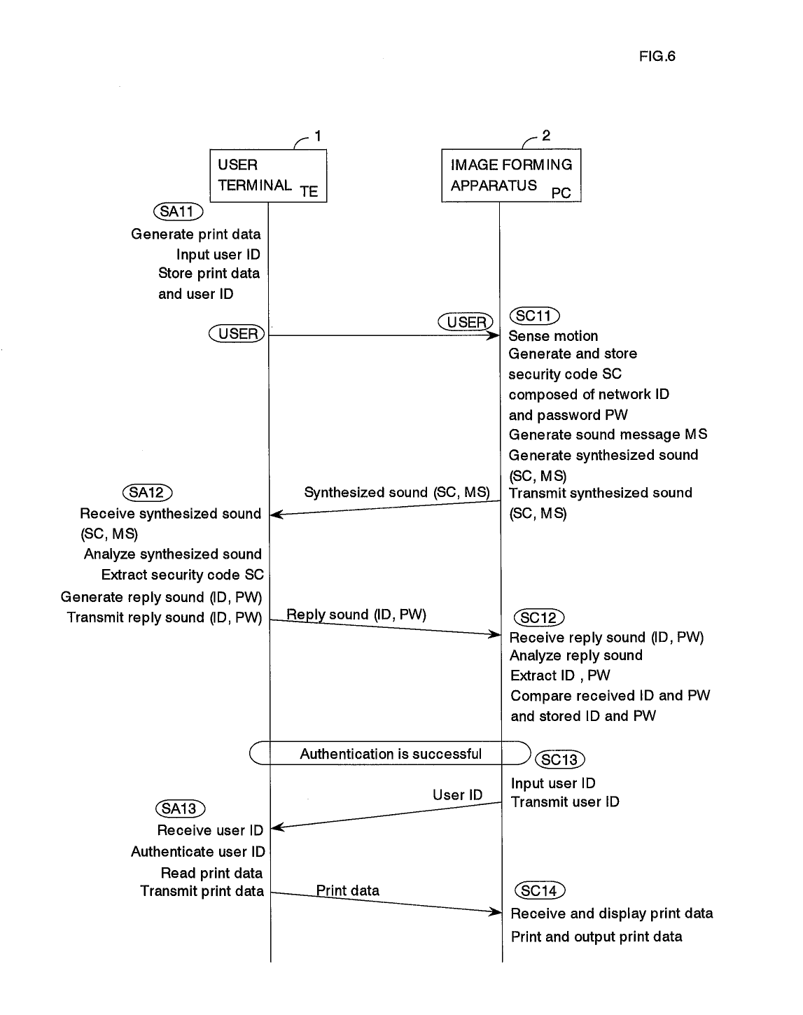

FIG. 6 is an explanatory view illustrating a sequence of a user authentication and data printing according to a second embodiment of the present invention.

This embodiment describes that the user comes to the PC2 to directly print print data via communication between the TE1 carried by the user and the PC2 without using the management server SV3.

In this case, the data the user intends to print is stored beforehand in the storage unit 20 of the TE1.

In step SA11 in FIG. 6, a user generates print data 23 with his/her user terminal TE1, inputs his/her user ID 22, and stores the print data 23 and the user ID 22 in the storage unit 20 of the TE1 in association with each other.

In step SC11, when the user visits a store having the PC2 with his/her TE1, and falls within a sensing area of the motion sensor 41 of the PC2, the motion sensor 41 senses this user, as in SC1 in FIG. 5.

When the PC2 senses a human body, the authentication information generating unit 42 generates a security code SC51 including a network ID and a password PW, and temporarily stores the generated security code SC51 into the storage unit 50.

The sound synthesizing unit 38 selects a sound message MS54, which should be outputted, from the storage unit 50, and generates a synthesized sound corresponding to the selected sound message MS.

At the same time, the sound synthesizing unit 38 generates a synthesized sound corresponding to the generated security code SC51, and also generates a synthesized sound formed by mixing the sound message MS and the security code SC.

Then, the synthesized sound (SC, MS) including the sound message MS and the security code SC is outputted from the speaker 35 of the PC2.

In step SA12, the microphone 16 of the TE1 carried by the user receives the synthesized sound outputted from the speaker 35, as in step SA2 in FIG. 5.

The input sound analyzing unit 17 of the TE1 analyzes the received synthesized sound, and extracts the security code SC included in this synthesized sound.

Then, the sound synthesizing unit 18 generates a reply sound (ID, PW), and outputs this reply sound from the speaker 15.

This reply sound includes the network ID and the password PW included in the extracted security code SC.

The network ID and the password PW may be outputted as a sound signal having an inaudible frequency area inaudible to human ears.

However, the reply sound may include a reply message that is audible to human ears.

In step SC 12, when the microphone 36 of the PC2 receives the reply sound (ID, PW), the input sound analyzing unit 37 of the PC2 analyzes the received reply sound (ID, PW) to extract the network ID and the password PW included in the reply sound.

Thereafter, the authentication confirmation unit 43 of the PC2 compares the extracted network ID and the password PW and a network ID51a and a password PW51b in the security code 51 generated by the PC2 and stored in the storage unit 50.

When both network IDs match and both passwords PW match, the authentication confirmation unit 43 determines that the user authentication is successful.

When the user authentication is successful, the display unit 34 may display that the authentication is successful, or the speaker 35 may output a sound indicating that the authentication is successful, in order to inform the user of the successful authentication.

In addition, the PC2 may display to the user with the display unit 34 or inform the user with a sound from the speaker 35 that he/she can perform his/her desired input operation for data printing, for example, because of the successful authentication.

In step SC13, the user depresses a key requesting printing and inputs a user ID from the input unit 33 of the PC2 to print the print data, which is generated by the user and stored in the TE1, on the PC2.

This user ID is the same as the user ID inputted in step SA11.

The inputted user ID is transmitted to the TE1 from the PC2.

In step SA13, the TE1 receives the user ID via the communication unit 12 of the TE1, and authenticates the user ID.

In the present embodiment, the TE1 compares the received user ID and the user ID 22 stored in the storage unit 20 of the TE1 to check whether they match or not.

When they match, the TE1 determines that the authentication of the user ID is successful.

When the authentication is successful, the TE1 reads print data 23 stored in the storage unit 20 of the TE1, and transmits the print data 23 to the PC2.

In step SC14, the print information acquiring unit 44 of the PC2 acquires the print data 52 via the communication unit 32, and temporarily stores the acquired print data in the storage unit 50, as in step SC4 in FIG. 5.

The print information acquiring unit 44 displays information relating to the acquired print data on the display unit 34.

Thereafter, the user confirms the displayed information, and performs an input operation for allowing printing with the input unit 33 of the PC2. Then, the printing unit 45 prints the print data 52 temporarily stored onto a predetermined sheet.

As described above, when print data generated by a user is stored in the TE1, a user authentication process using a synthesized sound is performed between the TE1 and the PC2 only when the user comes close to the PC2, installed at a store, with the TE1.

Specifically, the user authentication is automatically performed, even if the user does not read operating instructions of the PC2, and even if the user does not perform an operation of inputting a password with the input unit 33, upon a user authentication. This can reduce a burden for an input operation of a user who intends to use the PC2.

Conventionally, a user has to input a network ID and a password displayed on the display unit 34 of the PC2 with the input unit 13 of the TE1 in order to perform a user authentication between the TE1 and the PC2 for enabling wireless communication between the TE1 and the PC2, for example. It takes time to perform the input operation, and a burden of the input operation of the user is large.

However, the present invention has no need to perform a special input operation for a user authentication. Just after the automatic authentication is successful, the user can perform an input operation for a printing process of print data.

### Third Embodiment

The above first and second embodiments describe that a synthesized sound outputted from the PC2 is formed by mixing the sound message MS with a frequency in an audible area and a security code SC with a frequency in a non-audible area.

However, the synthesized sound is not limited thereto. Both the sound message MS and the security code SC may have a frequency in an audible area. In this case, the sound message MS and the security code SC, each of which has a different frequency band, may be mixed. It is to be noted that the levels of two sounds are preferably different in order that the sound message MS is easy to be heard.

On the contrary, the sound message MS and the security code SC may be sounds, each having a different frequency in an inaudible area, and these sounds may be synthesized. In this case, the outputted synthesized sound is inaudible to human ears, so that the authentication process is started before a user notices.

In addition, not only a sentence with a language understood by a human but also music or other audible sounds may be used as the sound message MS.

Like the synthesized sound outputted from the PC2, either one of a sound in an audible area and a sound in an inaudible area may be used for the synthesized sound (AS, PW) outputted from the TE1 in FIG. 5 and the reply sound (IP, PW) outputted from the TE1 in FIG. 6.

### Fourth Embodiment

The PC2 installed at a store used by a user is not limited to one, and plural PCs are sometimes installed.

When two users stand in front of the plural PCs, and a synthesized sound is almost simultaneously outputted from the plural PCs, the situation in which two synthesized sounds are received by a terminal TE of each user due to cross talk has to be prevented.

It is preferable to transmit and receive a synthesized sound only between a TE carried by a user and a PC to which this user comes close by a method in which a sound outputted from each PC is set to have directivity, and an outputting direction of a sound is limited to a front direction of the PC, or by a method in which a sound outputted from each PC is set to have a different frequency (pitch), for example.

### Fifth Embodiment

As described above, a user authentication process is performed to allow a user to use the PC2. In the first and second embodiments, the user authentication process is started, when the motion sensor of the PC2 senses a human body in order to avoid an input operation to start by a user who uses the PC2.

However, it is preferable to prevent an unnecessary authentication process from being performed, when a user having no intention of using the PC passes near the PC or just stops in front of the PC for a few seconds.

For example, the authentication process may be started in the case where a user stopping in front of the PC2 performs a predetermined key input operation on his/her TE1 to output a synthesized sound corresponding to this input operation to the PC2 from the TE1, and the PC2 receives this synthesized sound. In this case, the user indicates his/her intention of using the PC2 by outputting the synthesized sound through the predetermined key input operation.

### Sixth Embodiment

In order to further ensure security, an authentication process with other communication systems may also be used together with the authentication process of receiving and transmitting a synthesized sound described in the first and second embodiments.

For example, optical communication may be used as the other communication systems.

In addition, it may be configured such that the PC2 has two microphones, and when the strength of the received synthesized sound from the TE1 is almost equal to each other between two microphones, the PC2 determines that a user carrying the TE1 stands in front of this PC2, and that the authentication process is successful. When the strength of the received synthesized sound is greatly different between two microphones, it is considered that the user is not in front of the PC2, so that the PC2 determines that the authentication process is unsuccessful.

In this case, each of two microphones may be provided at a left end and at a right end of a front panel of a housing of the PC2, for example.

An authentication process can more surely be performed only when a user has an intention of using an apparatus without increasing a burden of an input operation of a user by any one of the processes in the above embodiments or by a combination of two or more processes described in the above embodiments. Thus, an unnecessary authentication process can be avoided.

According to the present invention, a user authentication is performed by comparing a security code transmitted in a form of a synthesized sound and a stored security code between a portable terminal and an image forming apparatus, whereby an input operation for setting for a user authentication can be eliminated, and a burden for an input operation of a user using the image forming apparatus can be reduced.

What is claimed is:

1. A user authentication system comprising: a portable terminal and an image forming apparatus, wherein,
the portable terminal provides a first sound output unit outputting a synthesized sound; and a first sound input unit receiving a synthesized sound outputted from the image forming apparatus, and
the image forming apparatus provides a second sound output unit outputting a synthesized sound; a second sound input unit receiving the synthesized sound outputted from the portable terminal; an authentication information generating unit generating a security code used for a user authentication; a storage unit storing the generated security code; and an authentication confirmation unit performing a user authentication by using the security code, wherein,
the second sound output unit in the image forming apparatus outputs a first synthesized sound including the stored security code,
when the first sound input unit in the portable terminal receives the first synthesized sound,
the first sound output unit outputs a second synthesized sound including the security code extracted from the received first synthesized sound,
the authentication confirmation unit compares the stored security code and the security code extracted from the second synthesized sound received by the second sound input unit, and
when both security codes match, the authentication confirmation unit determines that a user authentication is successful.

2. A user authentication system according to claim 1, wherein
the image forming apparatus further includes a motion sensor sensing that a human body is present within a predetermined distance, and
the second sound output unit outputs the first synthesized sound including the security code stored in the storage unit, when the motion sensor senses a human body.

3. A user authentication system according to claim 1, wherein
the first and second synthesized sounds include the security code and a predetermined sound message, and the security code is synthesized as a sound having a frequency band in a non-audible area.

4. A user authentication system according to claim 1, wherein
the first and second synthesized sounds include the security code and a predetermined sound message, and the security code and the sound message are respectively synthesized as sounds, each having a different frequency band to be outputted, simultaneously mixed, and outputted from the first and second sound output units.

5. A user authentication system according to claim 1, wherein
the security code includes a network ID and a password for identifying a portable terminal.

6. A user authentication system according to claim 1, wherein
after the user authentication by the authentication confirmation unit becomes successful, information that should be processed by the image forming apparatus is transmitted to the image forming apparatus from the portable terminal.

7. A user authentication system comprising: a portable terminal carried by a user and an image forming apparatus having functions, one of which is desired and used by a user, wherein,
the portable terminal provides a first sound output unit outputting a synthesized sound; a first sound input unit receiving a synthesized sound outputted from the image forming apparatus; a first communication unit; a first sound synthesizing unit generating a synthesized sound to be outputted from the first sound output unit; and
a first input sound analyzing unit analyzing the synthesized sound received by the first sound input unit, and
the image forming apparatus provides a second sound output unit outputting a synthesized sound; a second sound input unit receiving the synthesized sound outputted from the portable terminal; a second communication unit; a second sound synthesizing unit generating the synthesized sound to be outputted from the second sound output unit; a second input sound analyzing unit analyzing the synthesized sound received by the second sound input unit; an authentication information generating unit generating a security code used for a user authentication; a storage unit storing the generated security code; and an authentication confirmation unit confirming whether data communication between the portable terminal and the image forming apparatus is allowed or not by using the stored security code, wherein
the image forming apparatus generates a first synthesized sound, which includes the security code generated by the authentication information generating unit, by the second sound synthesizing unit, and outputs the generated first synthesized sound from the second sound output unit,
the portable terminal receives the outputted first synthesized sound by the first sound input unit, then, extracts the security code included in the received first synthesized sound by the first input sound analyzing unit, generates a second synthesized sound including the extracted security code by the first sound synthesizing unit, and outputs the generated second synthesized sound from the first sound output unit,
the image forming apparatus receives the outputted second synthesized sound by the second sound input unit, and then, extracts the security code included in the received second synthesized sound by the second input sound analyzing unit, and
when the stored security code and the security code extracted from the received second synthesized sound match, the authentication confirmation unit determines that an authentication is successful, and allows the data communication between the portable terminal and the image forming apparatus via the first communication unit and the second communication unit.

8. A user authentication system according to claim 7, wherein
the image forming apparatus further includes a motion sensor sensing that a human body is present within a predetermined distance, and
the second sound output unit outputs the first synthesized sound including the security code stored in the storage unit, when the motion sensor senses a human body.

9. A user authentication system according to claim 7, wherein
the first and second synthesized sounds include the security code and a predetermined sound message, and the security code is synthesized as a sound having a frequency band in a non-audible area.

10. A user authentication system according to claim 7, wherein
the first and second synthesized sounds include the security code and a predetermined sound message, and the security code and the sound message are respectively synthesized as sounds, each having a different frequency band to be outputted, simultaneously mixed, and outputted from the first and second sound output units.

11. A user authentication system according to claim 7, wherein
the security code includes a network ID and a password for identifying a portable terminal.

12. A user authentication system according to claim 7, wherein
after the user authentication by the authentication confirmation unit becomes successful, information that should be processed by the image forming apparatus is transmitted to the image forming apparatus from the portable terminal.

13. An image forming apparatus having a function for performing a user authentication, the image forming apparatus comprising:
a sound output unit outputting a synthesized sound; a sound input unit receiving a synthesized sound outputted from a portable terminal; a communication unit; a sound synthesizing unit generating the synthesized sound to be outputted from the sound output unit; an input sound analyzing unit analyzing the synthesized sound received by the sound input unit; an authentication information generating unit generating a security code used for a user authentication; a storage unit storing the generated security code; and an authentication confirmation unit confirming whether data communication between the portable terminal and the image forming apparatus is allowed or not by using the stored security code, wherein
the sound synthesizing unit generates a first synthesized sound including the security code generated by the authentication information generating unit, the sound output unit outputs the first synthesized sound,
and after the sound input unit receives a second synthesized sound outputted from the portable terminal, the input sound analyzing unit extracts a security code included in the received second synthesized sound, and when the stored security code and the security code extracted from the received second synthesized sound match, the authentication confirmation unit determines that an authentication is successful and allows the data communication between the portable terminal and the image forming apparatus.

14. A user authentication process for a system including a portable terminal and an image forming apparatus,
the portable terminal including a first sound output unit outputting a synthesized sound; and a first sound input unit receiving a synthesized sound outputted from the image forming apparatus, and
the image forming apparatus including a second sound output unit outputting a synthesized sound; a second sound input unit receiving the synthesized sound outputted from the portable terminal; an authentication information generating unit generating a security code used for a user authentication; a storage unit storing the generated security code; and an authentication confirmation unit performing a user authentication by using the security code, the process comprising:
outputting a first synthesized sound including the stored security code from the second sound output unit in the image forming apparatus,
receiving the first synthesized sound by the first sound input unit in the portable terminal;
outputting a second synthesized sound, which includes the security code extracted from the received first synthesized sound, from the first sound output unit;
comparing the stored security code and the security code extracted from the second synthesized sound received by the second sound input unit by the authentication confirmation unit; and
determining by the authentication confirmation unit that a user authentication is successful when both security codes match.
